(19) United States
(12) Patent Application Publication
(10) Pub. No.: US 2004/0243803 A1
(43) Pub. Date: Dec. 2, 2004

(54) Controlled-access method and system for transmitting scrambled digital data in a data exchange network

(76) Inventors: Andre Codet, Rennes (FR); Pierre Fevrier, St. Sulpice La Foret (FR)

Correspondence Address: Pearne Gordon McCoy & Granger, 526 Superior Avenue East, Suite 1200, Cleveland, OH, 44114-1484, US

(21) Appl. No.: 10/493,933

(22) PCT Filed: Oct. 24, 2002
(86) PCT No.: PCT/FR02/03655

(30) Foreign Application Priority Data
Oct. 29, 2001 (FR) 01 13963

(51) Int. Cl. H04L 9/00

(52) U.S. Cl. 713/171

(57) ABSTRACT

This invention relates to a method for transmission of digital data with access control to at least one terminal connected to a data exchange network (2), characterised in that it consists in:

scrambling data to be transmitted using a control word CW,

generating a digital sequence S for the terminal (4) calculated as a function of a first random data ALEA1 and data distinctive to the terminal in the network,

calculating at least one specific digital key K for the terminal (4) as a function of the digital sequence S and the control word CW,

transmitting the corresponding specific digital key K to the terminal (4).

### TECHNICAL DOMAIN

The invention is in the domain of broadcasting and access control to digital data, events, audiovisual programs and thematic channels broadcast in an environment open to terminals that do not have a security processor.

More particularly, the invention relates to a broadcasting method and system with access control to audiovisual programs to several terminals connected to an IP type network.

### STATE OF PRIOR ART

The DVB (Digital Video Broadcasting) standard includes an access control mechanism in which scrambling/descrambling information is transmitted to subscribers with ECM and EMM (Entitlement Control Message and Entitlement Management Message respectively) access control messages, and is stored in a memory card. This information comprises an encrypted control word CW that periodically changes, for example every ten seconds. A new control word corresponding to the same program or to a new program is transmitted to subscribers with ECM access control messages.

For example, ECMs are renewed every ten seconds and each ECM comprises three fields, a first field containing access parameters that define conditions of access to the scrambled program, for example such as parental control or geographic limitation of reception of the scrambled program, a second field comprising the control word CW encrypted by an operations key and a third field containing integrity checking parameters for the transmitted information.

EMMs generally comprise three fields, a first address field to select a decoder for a user or a user group, a second field containing access authorisation for the user or users, containing the operations key encrypted by a group key previously distributed to a subscriber group, and a third field containing integrity checking parameters for the transmitted information.

EMMs are transmitted before the programs to which they are applicable and are stored in a smart card.

When a decoder receives an EMM containing the encrypted operations key corresponding to its group, it checks whether or not this key has already been stored. If not, the operations key is decrypted by the inverse function of the encryption function and is then stored. In general, the decoder is composed of a terminal and a smart card integrating the security processor. And when the scrambled program is broadcast, the operations key is used to decrypt the control word CW associated with it and that is sent to subscribers through ECMs or written as soon as the receiver is initialised.

In the system described above, a subscriber needs to have equipment that generally comprises a security processor included in a smart card containing access parameters defining access rights to scrambled programs, in order to access the scrambled programs.

The access control system described above is not suitable for broadcasting through the Internet network since it would be unthinkable to distribute a smart card reader to every user connected to the networks due to the large number of potential subscribers and the geographic dispersion of these subscribers.

The purpose of the invention is to make a method of controlling access to scrambled data that might be read using terminals that do not include a security processor or a smart card.

More specifically, this method is applicable to two types of services; event-controlled broadcasting and broadcasting of television program channels.

Event-controlled broadcasting requires one channel for each event (music concert, sports event, training, etc.).

Broadcasting of television program channels relates to:

rebroadcasting of television channel programs,

rebroadcasting of channel programs by general subscription,

rebroadcasting of channels by general subscription with one or more thematic subscriptions,

creation and broadcasting of a channel including sequencing of its contents specific for subscription,

creation and broadcasting of a channel including sequencing of its contents specific for personnel,

creation and broadcasting of a channel including sequencing of its contents specific for the public.

### PRESENTATION OF THE INVENTION

The method according to the invention comprises three steps:

a first scrambling step consisting in:

scrambling digital data to be transmitted using a control word CW,

generating a digital sequence S for the terminal calculated as a function of a first random data ALEA1 and of data distinctive of the terminal in the network,

calculating at least one specific digital key K for the terminal as a function of the digital sequence S and of the control word CW,

transmitting the corresponding specific digital key K to the terminal,

a second broadcasting step consisting in:

transmitting scrambled digital data and the first random digital data ALEA1 to the terminal,

and a third descrambling step consisting in:

reconstituting the digital sequence S using the random data ALEA1 and the address of the terminal in the data exchange network,

decrypting the control word CW starting from the sequence S and the specific digital key K,

descrambling the scrambled digital data.

According to the invention, the method also comprises the following preliminary steps:

assign a reservation number to every user who has already reserved an access right to a service supplied through the network,

transmit the specific digital key K to this user in exchange for the said reservation number and the said digital data distinctive of the terminal in the network.

Preferably, the digital data distinctive of the terminal is the address of this terminal in the network.

According to the invention, the scrambled digital data are transmitted either by radio channel or by wire or by digital cable, or by a recording media.

According to the invention, the data exchange network is of the IP type.

According to the invention, the control word CW is preferably generated in a random manner.

According to the invention, the reservation number and the terminal address in the network are transmitted by the terminal user to the digital data supplier using the TCP/IP protocol.

According to the invention, the digital data may for example be audiovisual programs.

The method according to the invention comprises an additional step consisting in transmitting a second random data with the scrambled digital data to make a distinction between the scrambling/descrambling steps using an identical control word CW.

The method according to the invention comprises a step consisting in assigning a MultiCast address to each service supplied through the network and storing the MultiCast address, the random data (ALEA1) and the corresponding control words, CW in a services table.

According to the invention, the (ALEA1, CW) pair is changed regularly.

The validity duration of this pair may be fixed or variable.

In one particular application of the invention, each broadcast service comprises a plurality of elementary audio, basic video and enhanced video throughputs.

In this application, the scrambling step comprises the following sub-steps:

filter MultiCast address datagrams to be scrambled as a function of addresses and destination ports present in the header of the said datagrams,

scramble each datagram received at the input using the control word associated with the service,

add a header specific to access control to each datagram,

build a second datagram with an IP header containing the MultiCast address of the service, the Destination address, a destination port number dedicated to the descrambler and a useful content containing the scrambled input datagram and the header specific to the access control.

According to one variant embodiment of the invention, the broadcasting step consists in transmitting the second IP datagram through the IP network.

In this variant, the second IP datagram uses the UDP transport protocol, and the descrambling step comprises the following sub-steps:

analyse all received datagrams and, if one datagram has the MultiCast address and the port corresponding to the chosen service, then

delete the header specific to the access control,

descramble the useful content,

reinject the descrambled useful content onto the IP stack for processing by an application display module.

In a first case, the elementary audio and video throughputs of a given service are broadcast separately on the network using different destination ports. In this case, only the basic audio and video data are scrambled. The enhanced video data may or may not be scrambled.

In a second case, the elementary audio and video throughputs of a given service are multiplexed so that they only transmit a single service throughput on a given port. In this case, only the service throughput is scrambled.

The method according to the invention is implemented in a transmission system with access control of digital data scrambled by a control word CW to at least one terminal connected to a data exchange network comprising:

a reservation gateway,

a platform designed to scramble digital data to be transmitted,

a server designed to broadcast scrambled data.

According to the invention, the reservation gateway comprises:

means of generating a digital sequence S for the terminal as a function of a random data ALEA1 and data distinctive of the terminal in the network,

means of calculating a specific digital key K for the terminal, as a function of the digital sequence S and the control word CW.

According to the invention, the reservation gateway comprises:

means of assigning a reservation number to any user who has previously reserved an access right to a service supplied through the network,

means of transmitting the specific digital key K to this user in exchange for the said reservation number and the said digital data distinctive of the terminal in the network.

According to the invention, the reservation gateway also comprises a database designed to store a plurality of reservation numbers each corresponding to a specific individual key.

According to the invention, the reservation gateway comprises means of assigning a MultiCast address to each service supplied through the network and a memory containing a services table associating the corresponding MultiCast address, port, random data (ALEA1) and control word CW. Preferably, the (ALEA1, CW) pair is changed regularly.

Preferably, the control word CW is generated at random.

In one particular embodiment of the invention, the digital data represent audiovisual programs.

In this embodiment of the invention, the data exchange network is of the IP type and the said scrambling platform also comprises:

means of filtering IP datagrams of MultiCast addresses to be scrambled as a function of the addresses and destination ports present in the header of the said datagrams,

means of scrambling each datagram received at the input, using the control word associated with the service,

means of adding a header specific to the access control, to each datagram,

means of building a second datagram, with an IP header containing the MultiCast address of the service, the Destination address, a destination port number dedicated to the descrambler and a useful content containing the scrambled input datagram and the header specific to the access control.

The invention also relates to a scrambled digital data reception device comprising:

means of analysing all received datagrams, and if a datagram possesses the MultiCast address and the port corresponding to the chosen service, then

means of eliminating the header specific to access control,

means of descrambling the useful content,

means of reinjecting the descrambled useful content onto the IP stack through a port dedicated to processing and display of the received program.

The process according to the invention enables:

established operators (radio, television)

to broaden their audience,

to broaden their geographic coverage area,

to enrich their marketing offers,

to offer a personalised service (OnDemand video) due to interactivity.

new operators (specific content)

to offer theme contents,

to offer live programs not marketed by television operators (concert, sports, etc.),

to offer an internal communication media (employee) or external communication media (supplier) for companies.

### BRIEF DESCRIPTION OF THE DRAWINGS

Other characteristics and advantages of the invention will become clear from the following description, given as a non-limitative example with reference to the attached drawings in which:

FIG. 1 shows a broadcasting system according to the invention;

FIGS. 2 and 3 diagrammatically show two steps in initialisation of the method according to the invention;

FIG. 4 shows a block diagram illustrating a preferred embodiment of the method according to the invention;

FIGS. 5 and 6 diagrammatically illustrate a process for changing control words according to the invention.

### DETAILED PRESENTATION OF PARTICULAR EMBODIMENTS

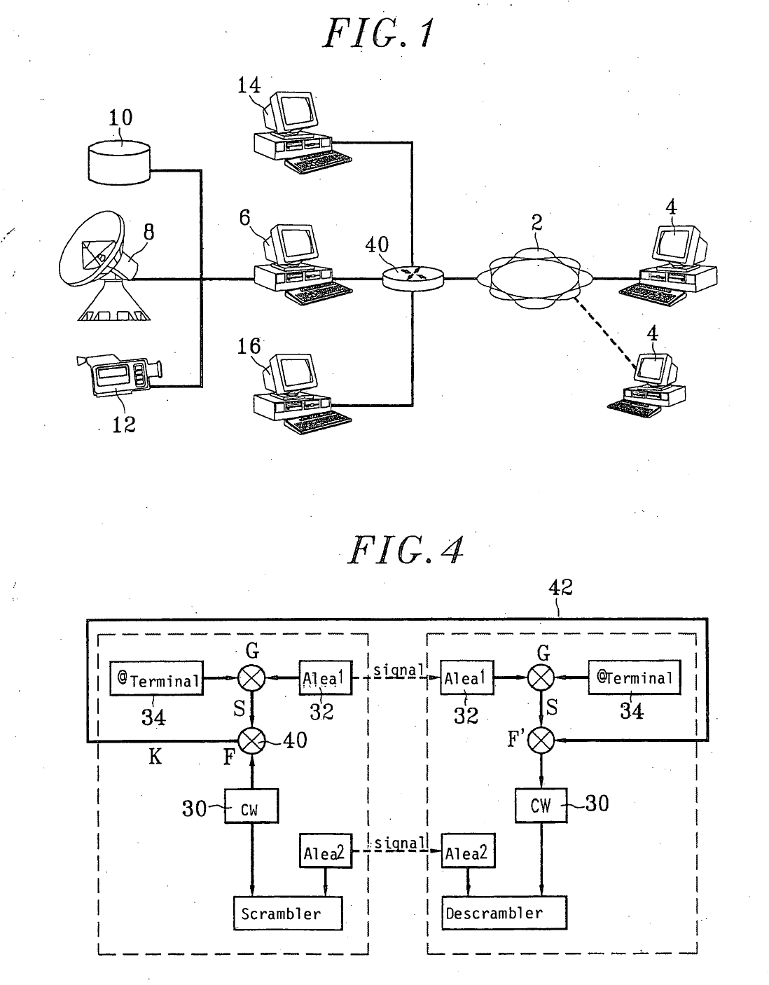

FIG. 1 diagrammatically shows a system that broadcasts scrambled audiovisual programs or thematic channels through the Internet network 2 to terminals 4 without necessarily having a security processor.

This system comprises a MultiCast broadcasting server 6 that transmits a single data packet to the terminals 4. The server 6 is connected to an antenna 8 for reception of audiovisual programs transmitted according to the MPEG2/MPEG4 standard, or to a database 10 or a source of television programs such as a pick-up camera 12. The server 6 is also connected to an audiovisual programs reservation gateway 14 and a scrambling platform 16.

The reservation gateway 14 is a computer containing software used to manage a presentation page of a commercial offer of audiovisual programs and to generate reservation numbers for access rights to these programs.

The scrambling platform 16 is connected to a computer comprising cryptographic software containing an encryption function G used to calculate individual keys.

Customer terminals 4 comprise software using a decryption function used to rebuild control words CW.

The process according to the invention will now be described with reference to FIGS. 2 to 6.

In one preferred embodiment of the invention, the process according to the invention is based on an “IP to UDP tunnel” solution, in other words an incoming IP/UDP datagram that is scrambled and then encapsulated in a new output IP/UDP datagram. This solution is described in a French patent application entitled “METHOD, SYSTEM AND DEVICE FOR CONDITIONAL ACCESS TO IP SERVICES” deposited by FRANCE TELECOM and registered as number 01 05318.

When a controlled audiovisual service is created, content distributors define the service input parameters (MultiCast address, etc.).

The customer station uses the method described in this application to descramble IP/UDP datagrams received through the network, to extract service input parameters and to present unencrypted broadcast programs to application level to display them.

Reserving an Access Right

The method according to the invention uses two preliminary steps to control access to broadcast programs:

the sale of reservation tickets represented by reservation numbers stored in the reservation gateway,

exchange of the ticket for one or more individual keys.

These two steps are independent. Obtaining a reservation key can:

be made some time before the broadcasting date of an event,

be made on a customer station other than the station used for the display,

originate from an advertising campaign,

be provided free of charge,

etc.

Each user obtains the individual key on the customer station. This key is unique for each terminal and is individualised using internal data that is specific to the customer terminal. The two prior steps (sale of reservation tickets and exchange of these tickets for an individual key) are necessary to access an event controlled audiovisual broadcast, and to obtain the parameters necessary for descrambling the broadcast program.

Generating a Reservation Ticket

The gateway 14 distributes reservation tickets after a user has purchased an event. Tickets are managed (generation, distribution) in the gateway 14. It is checked that the tickets have been generated and are unique before programs are distributed. All sold tickets are memorised in a database that contains the reservation tickets for events in progress and for future events. After the date of the event, the service is no longer supplied and memorised tickets are automatically deleted from the database.

FIG. 2 illustrates the reservation procedure according to an embodiment of the invention in which the user sends (arrow 20) a request to purchase one or more reservation tickets through the Internet network 2 to the gateway 14. The gateway 14 generates reservation numbers and returns (arrow 22) one or more reservation numbers to the customer terminal 4.

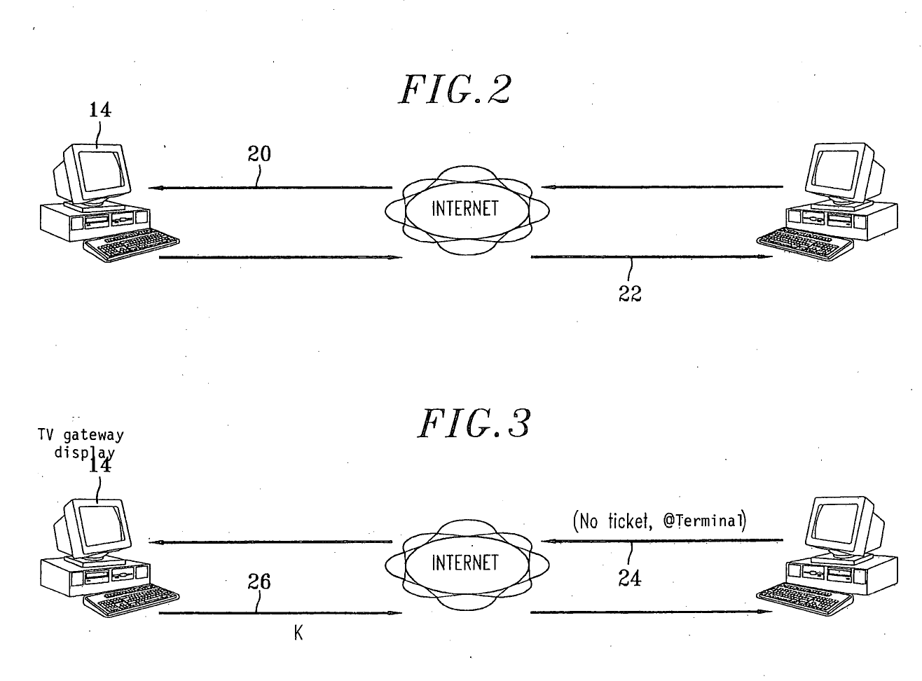

FIG. 3 illustrates the procedure for exchanging a reservation ticket with an individual key using this embodiment.

The user sends (arrow 24) an individual key request to the gateway 14. This request includes the number of the reservation ticket specific to a given program and thus the @TERMINAL address of the customer terminal 4.

When a user exchanges a reservation ticket to obtain an individual key, the @TERMINAL address that is the unique identifier of the user is registered in the database.

The gateway 14 manages one or more individual keys K and transmits them (arrow 26) to the user's terminal 4.

Generation and Distribution of the Individual Key(s)

The individual key(s) K is (are) generated when a user would like to display an event by exchanging a reservation ticket. The user supplies the terminal address (@Terminal) and the ticket number (ticket number) during the exchange request. The individual key is calculated as a function of this address.

Calculating the Individual Key

FIG. 4 represents a function block diagrammatically illustrating the calculation of the individual key.

A software module generates a control word CW (step 30) at random, with a first random digital data ALEA1 (step 32). The random data ALEA1 is then used to encrypt the address (@Terminal 34) of the user terminal 4, using a first function F. The encryption result is a digital sequence S given by the following expression:

S=F(ALEA1,@TERMINAL).

Note that the address (©TERMINAL) of the customer terminal in the network may be replaced by any parameter distinctive of this terminal in the network.

The next step consists of defining a specific digital key K=G (S, CW) resulting from encryption by the digital sequence S of the control word CW using a second function G.

When the customer asks that a reservation ticket should be exchanged for one or more individual keys K, this request is transmitted (arrow 42) to the customer terminal 4 in unicast through the Internet network before the scrambled programs are broadcast.

For each event purchased by a customer, the associated individual key(s) K are stored in the terminal of this customer.

Communication Between the Gateway 14/Broadcaster 6 and the scrambling platform 16

Communication between firstly the gateway 14, the broadcaster 6 and secondly the scrambling platform 16 is made by defining an API (Application Programming Interface) user interface, between the transmission point equipment (Gateway 14/servers 6) and the scrambling platform 16 to exchange parameters associated with the service or to request random generation of data ALEA1 and a control word CW when a service is created or when keys are changed.

Management of Services

The gateway 14 notifies the scrambling platform 16 about the different broadcast services. A MultiCast address is assigned for each service. A service contains several elementary throughputs (audio, basic video, enhanced video) to improve the reception quality of high range receivers that could process them. These elementary throughputs are either broadcast separately on the network 2 by using different destination ports, or are multiplexed to transmit only one throughput on a given port.

In the first case, only the audio and basic audio and video data are scrambled. Enhanced data may be scrambled or not scrambled.

In the second case, only the service throughput is scrambled.

The scrambling platform 16 manages data to be scrambled in service tables associating services, random data ALEA1 broadcast in the signal, control words CW for the MultiCast addresses and ports assigned to the services.

These tables are composed of a service location table I, a so-called profiles table II and an associations table III.

Example service tables

TABLE I
Service location

| Service_Id | @Multicast | No_Port |
|---|---|---|
| 1 | X | 2 |
| 1 | X | 3 |

TABLE II

Profiles table

| | | |
|---|---|---|
| Profile_CA_Id | ALEA | CW |

| | | |
|---|---|---|
| 10 | AA AA AA AA | BB BB BB BB |
| | AA AA AA AA | BB BB BB BB |
| 11 | CC CC CC CC | DD DD DD DD |
| | CC CC CC CC | DD DD DD DD |
| 12 | EE EE EE EE | AA AA AA AA |
| | EE EE EE EE | AA AA AA AA |
| 13 | FF FF FF FF | CC CC CC CC |
| | FF FF FF FF | CC CC CC CC |
| 14 | FF FF FF FF | CC CC CC CC |
| | FF FF FF FF | CC CC CC CC |

TABLE III
Association table

| @Multicast | No_Port | Profile_CA_Id (current |
|---|---|---|
| X | 2 | 10 |
| X | 3 | 10 |

The services location table I stores elementary throughputs of one or more services declared through the reservation gateway 14.

The profiles table II stores scrambling parameters (ALEA+CW) generated on the reservation gateway request 14.

The associations table III provides information about the current profile used in the crypto period being scrambled, for each elementary throughput.

Scrambling of IP/UDP Datagrams Output from the Server

Unencrypted IP/UDP datagrams supplied by the data server 6 are input to the scrambling platform 16. Depending on the addresses and destination ports present in the header of the IP/UDP datagrams, the scrambling platform 16:

filters IP/UDP datagrams from @MultiCast to be scrambled. These addresses are contained in the above services table,

scrambles the IP/UDP datagram received in the input using the control word associated with the service,

adds a header specific to the access control to the scrambled datagram, builds a second IP/UDP datagram with:

an IP header containing the MultiCast address of the service as the Destination address,

a port number dedicated to the descrambler as the destination port,

a useful content containing the IP/UDP scrambled input datagram (including header).

Remember that the random data ALEA1 is broadcast with the scrambled program and customers who have exchanged their reservation ticket will receive their individual key K in exchange.

Decrypting the Control Word

The customer terminal 4 cannot calculate the control word CW until it has received the random data ALEA1, in other words at the same time that it needs it to descramble the received data. The CW cannot be calculated without the individual key K and the individual address @TERMINAL of the customer terminal. This provides a means of detecting the origin of an illicit copy of an individual key, which is indissociable from the unique identifier of the customer terminal to which it was assigned. If such a type of fraud is detected, the customer terminal at which the fraud is made is automatically excluded from broadcasting of later individual key sets.

As explained above, the control word CW is calculated by a decryption function G′ as a function of the individual key K received in unicast and the digital sequence S calculated as a function of the random variable ALEA1 received with the scrambled program and the @TERMINAL address.

When the scrambled programs are broadcast, a second random data ALEA2 is combined with the control word CW to obtain a new scrambling/descrambling key that is transmitted to the customer terminal 4 at the same time as the random data ALEA1. This new data ALEA2 is used like an additional descrambling key and can be modified at specifically determined times, for example when sending a new datagram.

Reception and Descrambling of Received Scrambled Programs

The customer terminal receives scrambled or unscrambled datagrams. It analyses all these frames. If an IP/UDP datagram has a MultiCast address and the port corresponding to the chosen service, it:

deletes the IP/UDP header added by the scrambler,

descrambles the useful content,

reinjects the unscrambled useful content, in other words the IP/UDP header and the unencrypted content of the datagram on the IP stack through a port of the customer terminal dedicated to display of the received program.

The method described above may be used when making an isolated broadcasting of an event. In this case, a single individual key will be generated with a life equal to the duration of the event. However, this individual key may be replaced several times for the duration of the event.

Broadcasting a TV Channel

It is not appropriate to use a single key throughout the life of the event for this type of broadcast. The reception of a TV channel depends on subscriptions of a longer duration, for example monthly subscription, thematic subscription. To protect this reception method, it is essential that the control word CW should be changed as follows:

regularly in the case of a general subscription,

depending on broadcast contents, in the case of a thematic subscription.

General Subscription Mode

The contents distributor proposes reception of a TV channel on a customer terminal. Its display depends on a subscription being purchased, to access the program for a given period regardless of the contents.

For this type of subscription, the reservation ticket is treated like the purchase of this subscription. Each subscription renewal will be made after purchasing a reservation ticket. The first individual key will be distributed during exchange of the ticket corresponding to the purchased validation period. During the validity period of this subscription, control word changes will be necessary to secure reception of the program broadcast on all customer terminals for which rights were purchased.

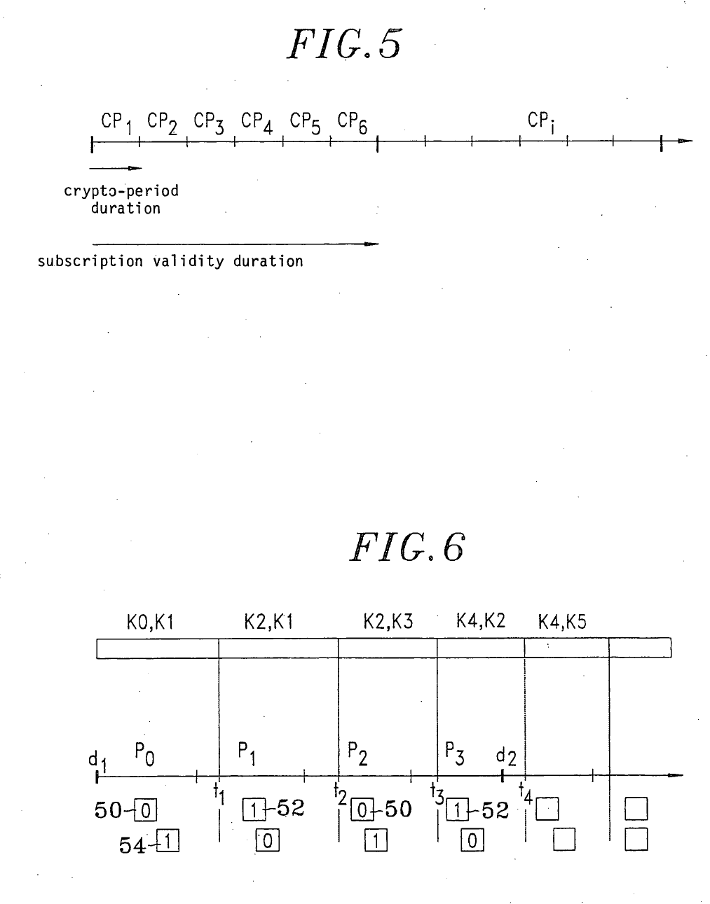

In one variant embodiment illustrated in FIGS. 5 and 6, the change to the control word comprises the following steps:

break down the subscription period into a series of crypto-periods CPᵢ, each corresponding to the life of a control word,

assign an even value to a crypto-period CPᵢ and an odd value to the next crypto-period CPᵢ₊₁, or an odd value to a crypto-period CPᵢ and an even value to the next crypto-period CPᵢ₊₁,

generate at least one even control word and at least one odd control word to be used, for each crypto-period CPᵢ,

transmit individual keys corresponding to the existing crypto-period and subsequent crypto-periods to rebuild even control words and the odd control word to be used, to each terminal,

transmit a change control word indicator to each terminal with the scrambled program, such that the customer terminal uses the even control word if the value assigned to the crypto-period is even, and the odd control word if the value assigned to the crypto-period is odd.

The change control word indicator is a digital value that changes parity every time the crypto-period is changed.

Preferably, the data throughput is transmitted on the same MultiCast address as video or audio data but with a different port number. This throughput will be identified in the SDP (Session Description Protocol) file or in the signalling throughput.

Starting from the parity change indicator supplied with the scrambled program, the terminal determines the time at which the new control word CW should be used.

If the value assigned to the crypto-period CPᵢ is even, the customer terminal uses the even control word (CW0, CW2, etc.) and if the value assigned to the crypto-period CPᵢ is odd, the customer terminal uses the odd control word (CW1, CW3, etc.).

The individual keys are not necessarily broadcast synchronously with the crypto-period changes indicated in the signal representing the audiovisual program. A second information will be used in the signal to indicate the moment at which customer terminals 4 must retrieve the individual key for the next crypto-period.

Every time that this information changes, the customer terminal must retrieve the individual key for the next crypto-period.

The diagram shown in FIG. 6 specifies operation of the system at the time that the key is changed.

In this figure, a subscription duration D located between a first date d1 and a final date d2 is broken down into a sequence of four phases (p₀, p₁, p₂, p₃) each corresponding to a crypto-period. The binary value 0 (reference 50) is assigned to even pairs p₀ and p₂, and the binary value 1 (reference 52) is assigned to odd phases p₁ and p₃. Throughout the duration D of the subscription, a series of pairs of control words (CW0, CW1), (CW2, CW1), (CW2, CW3), (CW4, CW3) is transmitted in the form of a sequence of pairs of individual keys (K0, K1), (K2, K1), (K2, K3), (K4, K3) to customer terminals with times t1, t2, t3 and t4 for successive changes of the control word. Terminals receive the pair of words in the individual key (K0, K1) and use K0 throughout the first phase p₀.

Terminals will use the odd control word K1 during the odd phase p₁. The same procedure is used during subsequent phases.

Thus, whenever a connection to the TV channel is made, in other words after the reservation ticket has been exchanged for an individual key, the customer terminal retrieves the “even and odd” individual keys to be used.

Two solutions could be envisaged for this retrieval:

individual keys are retrieved in the data throughput before beginning descrambling of IP/UDP datagrams. This solution is possible if the number of potential users is not very high,

individual keys are retrieved by making a connection with the gateway 14 and then, if the customer terminal identifies an even phase datagram, it uses the even control word until the next change, and if it identifies an odd phase datagram, it uses the odd control word until the next change.

Thematic Subscription

The process described above can be used in this subscription mode.

However, for a program broadcast with this subscription type, all broadcast events and their theme have to be identified. For example, event 1 (sports), event 2 (cinema), event 3 (news), etc. Each event in this broadcast will be linked to a key change.

For transmission equipment, this information must be known and adapted to make it transmittable in the signal coded according to MPEG4 standard.

1. Method for transmission of digital data with access control to at least one terminal (4) connected to a data exchange network (2), characterised in that it comprises three steps:
a first scrambling step consisting in:
scrambling digital data to be transmitted using a control word CW,
generating a digital sequence S for each terminal calculated as a function of a first random data ALEA1 and of data distinctive of the terminal in the network,
calculating at least one specific digital key K for the terminal (4) as a function of the digital sequence S and the control word CW,
transmitting the corresponding specific digital key K to the terminal (4),
a second broadcasting step consisting in:
transmitting scrambled digital data and the random digital data ALEA1 to the terminal (4),
and a third descrambling step consisting in:
reconstituting the digital sequence S using the random data ALEA 1 and the address of the terminal in the network (2),
decrypting the control word CW starting from the sequence S and the specific digital key K,
descrambling the transmitted digital data.

2. Method according to claim 1, characterised in that it also comprises the following steps:
assign a reservation number to every user who has already reserved an access right to a service supplied through the network (2),
transmit the specific digital key K to this user in exchange for the said reservation number and the said digital data distinctive of the terminal in the network (2).

3. Method according to claim 2, characterised in that the digital data are transmitted either by radio channel or by wire or by digital cable, or by a recording media of digital data.

4. Method according to claim 2, characterised in that the data exchange network (2) is of the IP type.

5. Method according to claim 4, characterised in that the distinctive digital data is the address of the terminal in the network (2).

6. Method according to claim 1, characterised in that the control word CW is generated at random.

7. Method according to claim 2, characterised in that the reservation number and the address of the terminal in the network (2) are transmitted by the terminal user to the program supplier using the TCP/IP protocol.

8. Method according to claim 1, characterised in that the digital data are audiovisual programs.

9. Method according to claim 1 characterised in that it comprises an additional step consisting in transmitting a second random data (ALEA2) with the scrambled digital data to be used as an additional descrambling key in combination with the control word CW.

10. Method according to claim 4, characterised in that it comprises a step consisting in assigning a Multicast address to each service supplied through the network (2) and storing the Multicast address, the corresponding random data (ALEA1) and the control word CW in a services table.

11. Method according to claim 10, characterised in that the (ALEA1, CW) pair is changed regularly.

12. Method according to claim 10, characterised in that each broadcast service comprises a plurality of elementary audio, basic video and enhanced video throughputs.

13. Method according to claim 12, characterised in that the scrambling step comprises the following sub-steps:
filter MultiCast address IP datagrams to be scrambled as a function of addresses and destination ports present in the header of the said datagrams,
scramble each datagram received at the input using the control word associated with the service,
add a header specific to access control to each datagram,
build a second IP datagram with an IP header containing the MultiCast address of the service, the Destination address, a destination port number dedicated to the descrambler and a useful content containing the scrambled input datagram and the header specific to the access control.

14. Method according to claim 13, characterised in that the broadcasting step consists of transmitting the second IP datagram through the IP network.

15. Method according to claim 14, characterised in that the second IP datagram uses the UDP transport protocol.

16. Method according to claim 13, characterised in that the descrambling step comprises the following sub-steps:
analyse all received datagrams and, if one datagram has the MultiCast address and the port corresponding to the chosen service, then
delete the header specific to the access control,
descramble the useful content,
reinject the descrambled useful content onto the IP stack through a port dedicated to processing and display of the received program.

17. Method according to claim 16, characterised in that the elementary audio and video throughputs for a given service are broadcast separately on the network by using different destination ports.

18. Method according to claim 16, characterised in that the elementary audio and video throughputs for a given service are multiplexed to transmit only one service throughput on a given port.

19. Method according to claim 17, characterised in that only the audio and basic video data are scrambled.

20. Transmission system with access control of digital data scrambled by a control word CW to at least one terminal (4) connected to a data exchange network (2) comprising:
a reservation gateway (14),
a platform (16) designed to scramble data to be transmitted,
a server (6) designed to broadcast scrambled data, system characterised in that the reservation gateway (14) comprises:
means of generating a digital sequence S as a function of a random data ALEA1 and data distinctive of the terminal in the network (2),
means of calculating a specific digital key K for the terminal (4), as a function of the digital sequence S and the control word CW.

21. System according to claim 20, characterised in that the said distinctive data of the terminal in the network (2) consists of the address of the terminal in this network.

22. System according to claim 21, characterised in that the said reservation gateway comprises:
means of assigning a reservation number to any user who has previously reserved an access right to a service supplied through the network (2),
means of transmitting the specific digital key K to this user in exchange for the said reservation number and the said digital data distinctive of the terminal in the network (2).

23. System according to claim 22, characterised in that the said reservation gateway (14) also comprises a database designed to store a plurality of reservation numbers each corresponding to a specific key.

24. System according to claim 21, characterised in that the data exchange network (2) is of the IP type.

25. System according to claim 24, characterised in that the said reservation gateway (14) comprises means of assigning a MultiCast address to each service supplied through the network (2) and a memory containing a services table associating the corresponding MultiCast address, the random data (ALEA1) and the control word CW.

26. System according to claim 25, characterised in that the control word CW is generated at random.

27. System according to claim 21, characterised in that the digital data are audiovisual programs.

28. System according to claim 27, characterised in that the said scrambling platform (16) also comprises:
means of filtering IP datagrams of MultiCast addresses to be scrambled as a function of the addresses and destination ports present in the header of the said datagrams,
means of scrambling each IP datagram received at the input, using the control word associated with the service,
means of adding a header specific to the access control, to each IP datagram,
means of building a second datagram, with an IP header containing the MultiCast address of the service, the Destination address, a destination port number dedicated to the descrambler and a useful content containing the scrambled input datagram and the header specific to the access control.

29. System according to claim 28, characterised in that it comprises a reception device adapted for:
analysing all received IP datagrams, and if a datagram possesses the MultiCast address and the port corresponding to the chosen service, then
eliminating the header specific to access control,
descrambling the useful content,
reinjecting the descrambled useful content onto the IP stack through a port dedicated to processing and display of the received program.

30. Reception device for scrambled digital data, characterised in that it comprises:
means of analysing all received datagrams, and if a datagram possesses the MultiCast address and the port corresponding to the chosen service, then
means of eliminating the header specific to access control,
means of descrambling the useful content,
means of reinjecting the descrambled useful content onto the IP stack through a port dedicated to processing and display of the received program.

31. Method for changing the control word for access to scrambled data, characterised in that it comprises the following steps:
break down the subscription period into a series of crypto-periods CPᵢ, each corresponding to the life of a control word (CWᵢ),
assign an even value to a crypto-period CPᵢ and an odd value to the next crypto-period CPᵢ₊₁, or an odd value to a crypto-period CPᵢ and an even value to the next crypto-period CPᵢ₊₁,
generate at least one even control word and at least one odd control word for each crypto-period CPᵢ,
transmit a data throughput containing the address of the terminal (4) to the terminal (4), and a random data ALEA1 to change control word parity,
transmit a change control word indicator to the terminal (4), such that this terminal (4) uses the even control word if the value assigned to the crypto-period is even, and the odd control word if the value assigned to the crypto-period is odd.

32. Method according to claim 31, characterised in that the data exchange network (2) is of the IP type.

33. Method according to claim 32, characterised in that exchanged digital data are audiovisual programs.

34. Method according to claim 31, characterised in that the change control word indicator is a digital value transmitted with the scrambled program that changes parity every time the crypto-period is changed.

35. Method according to claim 34, characterised in that after a reservation ticket has been exchanged for one or more specific individual keys K, the customer terminal (4) retrieves the encrypted even and odd individual keys in the data throughput before beginning descrambling of IP/UDP datagrams.

36. Method according to claim 35, characterised in that after each reservation ticket exchange, the customer terminal retrieves even and odd individual keys by connecting to the gateway (14).

37. Method according to claim 35, characterised in that the customer terminal (4) uses the even control word until the next value of the change indicator if it identifies an even phase datagram, or uses the odd control word until the next value of the change indicator if it identifies an odd phase datagram.
